(19) United States
(12) Patent Application Publication
(10) Pub. No.: US 2022/0248119 A1
(43) Pub. Date: Aug. 4, 2022

(54) SOUND PRIVACY PROTECTION DEVICE

(71) Applicant: SHENZHEN DASHI SCIENCE AND TECHNOLOGY CO., LTD., Shenzhen (CN)

(72) Inventors: Haoqian Li, Shenzhen (CN); Jiang Chen, Shenzhen (CN)

(21) Appl. No.: 17/535,709

(22) Filed: Nov. 26, 2021

(30) Foreign Application Priority Data
Feb. 3, 2021 (CN) 202110147859.5

(51) Int. Cl. H04R 1/10

(52) U.S. Cl. CPC H04R 1/1016; H04R 2460/11

(57) ABSTRACT

A sound privacy protection device is provided, including: a wearable structure configured to be worn at an ear; and a mount structure connected to the wearable structure, where the mount structure is provided with at least one sound generating unit; the mount structure is provided with at least one front vent for guiding the sound generating unit; and an acoustic outlet end of the front vent is arranged close to an ear canal entrance point (EEP). According to the present invention, the front vent and the reverse vent are both arranged on the mount structure, and the front vent and the reverse vent are positioned at the set points through the wearable structure, such that the sound waves of the reverse vent and the front vent cancel each other out in the afar sound fields, thereby achieving the purpose of sound elimination, preventing the surroundings from hearing the sound emitted by the device and protecting privacy.

### TECHNICAL FIELD

The present invention relates to the field of earpieces, and more particularly to a sound privacy protection device.

### BACKGROUND

In the existing audio product design, for example, the vents of glasses and hanging earpieces are far away from the ear canal entrance point (EEP), and when the audio devices play at a high volume, loud sound may be leaked to the outside, which may affect the surroundings or reveal the privacy of users.

### SUMMARY

The purpose of the present invention is to overcome the shortcomings of the related art by providing a sound privacy protection device. To achieve the above purpose, the present invention uses the following technical scheme:

a sound privacy protection device, including: a wearable structure configured to be worn at an ear; and a mount structure connected to the wearable structure, where the mount structure is provided with at least one sound generating unit; the mount structure is provided with at least one front vent for guiding the sound generating unit; and an acoustic outlet end of the front vent is arranged close to an ear canal entrance point (EEP).

Further, the mount structure is provided with at least one reverse vent; and the reverse vent is arranged close to an ear reference point (ERP).

Further, the front vent is in communication with an acoustic outlet end of the sound generating unit, and the reverse vent is in communication with a rear end of the sound generating unit; and the front vent and the reverse vent are located in the mount structure and sealed from each other.

Further, the EEP is an origin of a spatial coordinate system, with a direction from the EEP to an outer side of the ear defined as a positive X-axis, a direction from the EEP to a front side of the ear defined as a positive Y-axis, and a direction from the EFT to an upper side of the ear defined as a positive Z-axis; coordinates of the acoustic outlet end of the front vent are between (0 mm, −12.2 mm, −5.2 mm) and (15.3 mm, 3.2 mm, 13.3 mm); and coordinates of an acoustic outlet end of the reverse vent are between (5 mm, −22 mm, −3.2 mm) and (27.3 mm, 15 mm, 18 mm).

Further, the ERP is an origin of a spatial coordinate system, with a direction from the ERP to an outer side of the ear defined as a positive X-axis, a direction from the ERP to a front side of the ear defined as a positive Y-axis, and a direction from the ERP to an upper side of the ear defined as a positive Z-axis; coordinates of the acoustic outlet end of the front vent are between (0 mm, −9.2 mm, −18.2 mm) and (7.3 mm, 10.4 mm, 8.2 mm) and coordinates of an acoustic outlet end of the reverse vent are between (5 mm, −15.2 mm, −3.2 mm) and (20.3 mm, 12 mm, 13 mm).

Further, a cross-sectional area of the front vent is 10% to 35% of an, area of a diaphragm of the sound generating unit.

Further, a cross-sectional area of the reverse vent is 10% to 30% of an area of a diaphragm of the sound generating unit.

Further, the number of the front vent is equal to the number of the reverse vent. Further, the front vent or the reverse vent has a circular shape, a square shape, an elliptical shape or a racetrack shape, or any combination thereof.

Further, the front vent is arranged on one side of the mount structure facing toward an ear canal; and the reverse vent is arranged on one side of the mount structure facing away from the ear canal.

Compared with the related art, the present invention has the following beneficial effects: According to the present invention, the front vent and the reverse vent are both arranged on the mount structure, and the, front vent and the reverse vent are positioned at the set points by means of the wearable structure, such that the sound waves of the reverse vent and the front vent cancel each other out in the far sound fields, thereby achieving the purpose of sound elimination, preventing the surroundings from hearing the sound emitted by the device and protecting privacy.

The aforementioned description is only an overview of the technical schemes of the present invention. In order to clearly understand the technical means of the present invention, the present invention can be implemented according to the contents of the specification; and in order to make the aforementioned and other purposes, features, and advantages of the present invention more obvious and understandable, preferred embodiments are described in detail below.

### BRIEF DESCRIPTION OF DRAWINGS

FIG. 1 is a schematic diagram of a sound privacy protection device of the present invention when worn at an ear;

FIG. 2 is a cross-sectional view taken along line A-A in FIG. 1;

FIG. 3 is a schematic diagram of the sound privacy protection device of the present invention when worn at an ear; and

FIG. 4 is a cross-sectional view taken along line B-B in FIG. 3.

### DETAILED DESCRIPTION

In order to make the purpose, technical schemes, and advantages of the present invention more clearly understood, the present invention is illustrated in further detail below in conjunction with particular embodiments and accompanying drawings.

The technical schemes in the embodiments of the present invention are clearly and completely described in the following with reference to the drawings in the embodiments of the present invention. It is obvious that the described embodiments are only some of the embodiments of the present invention and are not all the embodiments. All other embodiments obtained by those of skill in the art based on the embodiments of the present invention without inventive effort shall fall within the scope of the present invention.

In the description of the present invention, it should be understood that descriptions relating to orientation, for example, orientation or positional relationships indicated by “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc. are based on the orientation or positional relationships shown in the accompanying drawings, and are to facilitate the description of the present invention and simplify the description only, rather than indicating or implying that the device or element referred to must have a specific orientation or be constructed and operated in a specific orientation, and therefore cannot be construed as limiting the present invention.

In addition, the terms “first” and “second” are for the purpose of description only and should not be construed as indicating or implying relative importance or implicitly indicating the number of technical features indicated. Thus, features defined with “first” and “second” may include one or more of the features either explicitly or implicitly. In the description of the present invention, the term “a plurality of” means two or more, unless otherwise explicitly and specifically defined.

In the description of the present invention, terms such as “mount”, “engage”, “connect” and “fix” should be interpreted in a broad sense unless explicitly defined and limited otherwise, which, for example, can mean a connection, a detachable connection or being integrally formed; can mean a mechanical connection or an electrical connection; and can mean a direct connection, an indirect connection by means of an intermediary, or internal communication between two elements or an interaction relationship between two elements. For those of ordinary skill in the art, the specific meaning of the terms mentioned above in the present invention should be construed according to specific circumstances.

In the present invention, unless otherwise explicitly specified or defined, a first feature being “on” or “under” a second feature can include situations where the first feature is in direct contact with the second feature, and, can also include situations where the first and second features are in indirect contact by means of another feature therebetween, instead of being in direct contact with each other. Moreover, a first feature being “on”, “above” or “over” a second feature includes situations where the first feature is directly above or obliquely above the second feature, or simply indicates that the first feature is higher in level than the second feature. A first feature being “under”, “below” or “underneath” a second feature includes situations where the first feature is directly below or obliquely below the second feature, or simply indicates that the first feature is lower in level than the second feature.

In this specification, the description with reference to terms such as “one embodiment”, “some embodiments”, “example”, “specific example”, and “some examples” means that the specific features, structures, materials, or features described in conjunction with the embodiment(s) or example(s) are included in at least one embodiment or example of the present invention. In this specification, the illustrative expression of the above-mentioned terms should not be understood as necessarily referring to the same embodiments or examples. Moreover, the specific features, structures, materials, or characteristics described can be combined in any one or more embodiments or examples in any suitable manner. In addition, those skilled in the art can integrate and combine different embodiments or examples described in this specification.

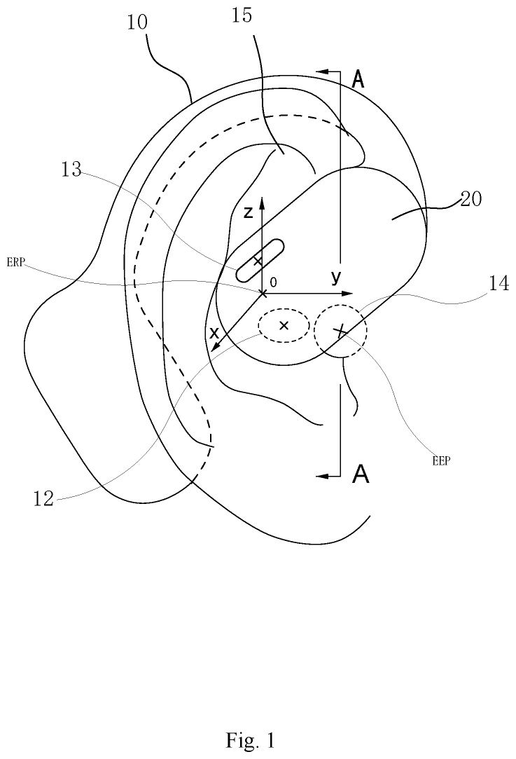

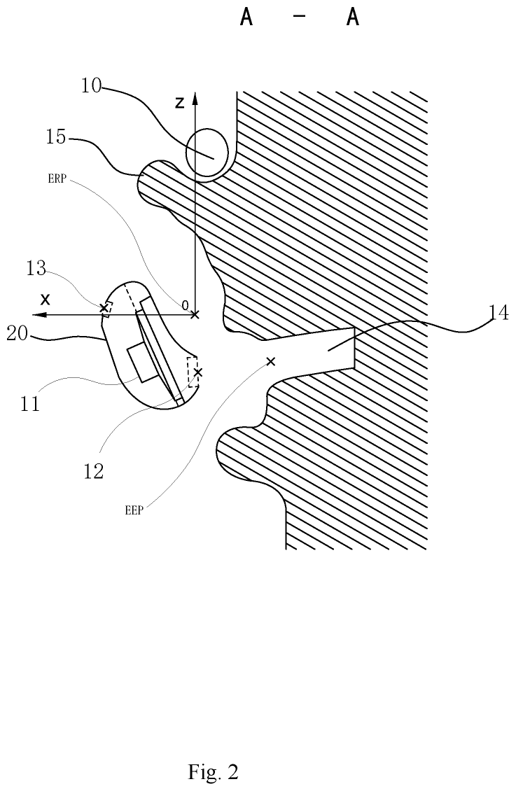

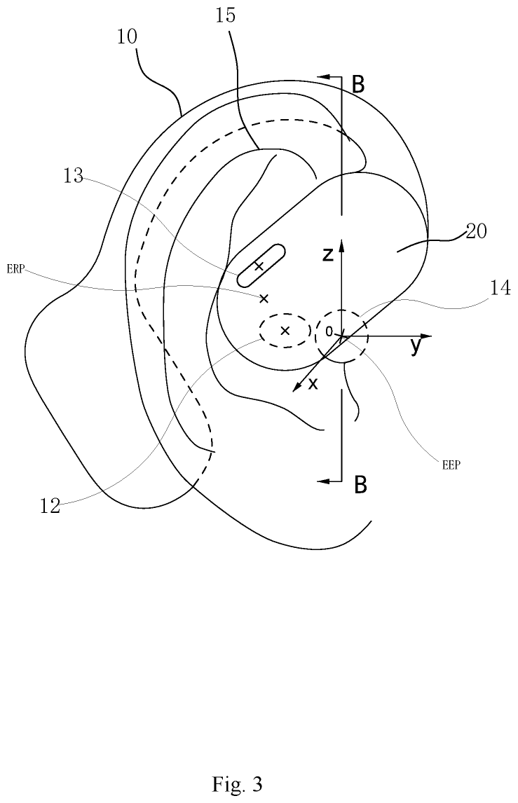

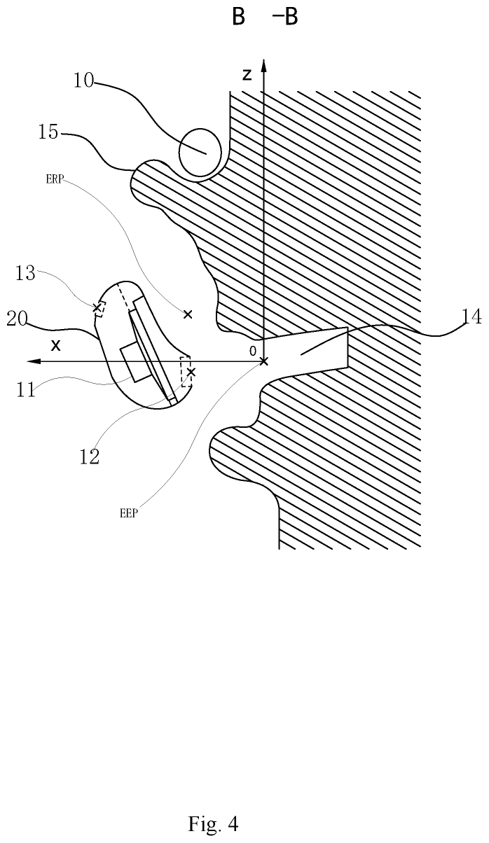

FIGS. 1-4 are drawings of the present invention.

This embodiment provides a sound privacy protection device, referring to FIGS. 1-4, including a wearable structure 10 configured to be worn at an ear; and a mount structure 20 connected to the wearable structure 10. The mount structure 20 is provided with at least one sound generating unit 11. The mount structure is provided with at least one front vent 12 for guiding the sound generating unit 11. An acoustic outlet end of the front vent 12 is arranged close to an ear canal entrance point (EEP), which enables effective transmission of the sound from the sound generating unit 11 to the ear canal. The front vent 12 is located at the entrance end of the ear canal in a suspended manner.

The mount structure 20 is provided with at least one reverse vent 13. The reverse vent 13 is arranged close to an ear reference point (ERP). There is a set distance between the acoustic outlet end of the front vent 12 and the acoustic outlet end of the reverse vent 13, such that the outgoing audio can interact with each other and cancel each other out, thereby preventing sound leakage.

In the figure, reference numeral 14 denotes an ear canal and 15 denotes a human ear.

Here, EEP is the entrance of an ear canal, and ERP is a reference point of an ear, which are specified in ITU-T P.57 issued by Telecommunication Standardization Sector of the International Telecommunications Union (ITU).

The front vent 12 of the sound generating unit 11 is close to the EEP but does not make contact with the EEP. The front vent 12 and the reverse vent 13 are spatially close to the EEP and the ERP, respectively. The front vent 12 is located at a distance from the reverse vent 13 in space so as to achieve the maximum sound attenuation effect in the far-field sound attenuation.

The sound waves of the reverse vent 13 and the front vent 12 are opposite in phase and the same in amplitude, and the sound waves from the two vents cancel each other out in the far sound fields, thus achieving the purpose of sound elimination, preventing the surroundings from hearing the sound emitted by the device and protecting privacy.

The front vent 12 is in communication with an acoustic outlet end of the sound generating unit 11, while the reverse vent 13 is in communication with a rear end of the sound generating unit 11. The front vent 12 and the reverse vent 13 are located in the mount structure 20 and sealed from each other, so as to prevent the front vent 12 and the reverse vent 13 from interfering with each other in the device and adversely affecting the sound output effect of the front vent 12.

Here, in order to better express the spatial positions of the front vent 12 and the reverse vent 13, the EEP is taken as an origin of a spatial coordinate system, with a direction from the EEP to an outer side of the ear defined as a positive X-axis, a direction from the EEP to a front side of the ear defined as a positive Y-axis, and a direction from the EEP to an upper side of the ear defined as a positive Z-axis. The coordinates of the acoustic outlet end of the front vent 12 are between (0 mm, −12.2 mm, −5.2 mm) and (15.3 mm, 3.2 mm, 13.3 mm), which can be understood as a center point of the acoustic outlet end of the front vent 12 being located at any point on a line between the two points (0 mm, −12.2 mm, −5.2 mm) and (15.3 mm, 3.2 mm, 13.3 mm). The coordinates of an acoustic outlet end of the reverse vent 13 are between (5 mm, −22 mm, −3.2 mm) and (27.3 mm, 15 mm, 18 mm). Similarly, a center point of the acoustic outlet end of the reverse vent 13 may be located at any point on a line between the two points (5 mm, −22 mm, −3.2 mm) and (27.3 mm, 15 mm, 18 mm).

In another embodiment, the ERP is an origin of a spatial coordinate system, with a direction from the ERP to an outer side of the ear defined as a positive X-axis, a direction from the ERP to a front side of the ear defined as a positive Y-axis, and a direction from the ERP to an upper side of the ear defined as a positive Z-axis. The coordinates of the acoustic outlet end of the front vent 12 are between (0 mm, −9.2 mm, −18.2 mm) and (7.3 mm, 10.4 mm, 8.2 mm), which can be understood as a center point of the acoustic outlet end of the front vent 12 being located at any point on a line between the two points (0 mm, −9.2 mm, −18.2 mm) and (7.3 mm, 10.4 mm, 8.2 mm). The coordinates of an acoustic outlet end of the reverse vent 13 are between (5 mm, −15.2 mm, −3.2 mm) and (20.3 mm, 12 mm, 13 mm). Similarly, a center point of the acoustic outlet end of the reverse vent 13 may be located at any point on a line between the two points (5 mm, −15.2 mm, −3.2 mm) and (20.3 mm, 12 mm, 13 mm).

Optionally, a cross-sectional area of the front vent 12 is 10% to 35% of an area of a diaphragm of the sound generating unit 11, so that sound from the sound generating unit 11 can be focused to improve the sound guiding effect of the front vent 12.

Further, a cross-sectional area of the reverse vent 13 is 10% to 30% of an area of the diaphragm of the sound generating unit 11, so that the energy of the diaphragm of the sound generating unit 11 can be transmitted through the front vent 12. The reverse vent 13 is in communication with a rear end of the sound generating unit 11, so that the rear end of the sound generating unit 11 can ventilate when the sound generating unit 11 vibrates. Optionally, the number of the front vent 12 is equal to the number of the reverse vent 13, and the center points of the acoustic outlet ends of the front vent 12 and the reverse vent 13 all fall within the coordinate points of the above coordinate system.

The front vent 12 or the reverse vent 13 has a circular shape, a square shape, an elliptical shape or a racetrack shape, or any combination thereof.

Further, the front vent 12 is arranged on one side of the mount structure 20 facing toward an ear canal, and the reverse vent 13 is arranged on one side of the mount structure 20 facing away from the ear canal.

The wearable structure 10 is a curved structure, which can be hung over the ear and used for securing the whole earpiece. Preferably, the wearable structure 10 is made of memory materials, which is conducive to matching the contour of ears. In other embodiments, the wearable structure 10 can also be secured to the ear in other manners, not limited to the above-mentioned hanging manner. The function of the wearable structure 10 is only to secure the earpiece, and to ensure that the front vent 12 and the reverse vent 13 on the mount structure 20 can be positioned at the above points.

Compared with the related art, in the present invention, the front vent 12 and the reverse vent 13 are both arranged on the mount structure, and the front vent 12 and the reverse vent 13 are positioned at the set points through the wearable structure 10, such that the sound waves of the reverse vent 13 and the front vent 12 cancel each other out in the far sound fields, thereby achieving the purpose of sound elimination, preventing the surroundings from hearing the sound emitted by the device and protecting privacy.

The above embodiments are used merely to further explain the technical content of the present invention, so that readers can understand the present invention more easily, and it is not intended that the embodiments of the present invention are limited thereto, and any technical extension or re-creation according to the present invention is protected by the present invention. The scope of protection of the present invention is subject to the appended claims.

1. A sound privacy protection device, comprising: a wearable structure configured to be worn at an ear; and a mount structure connected to the wearable structure, wherein the mount structure is provided with at least one sound generating unit; the mount structure is provided with at least one front vent for guiding the sound generating unit; and an acoustic outlet end of the front vent is arranged close to an ear canal entrance point (EEP).

2. The sound privacy protection device of claim 1, wherein the mount structure is provided with at least one reverse vent; and the reverse vent is arranged close to an ear reference point (ERP).

3. The sound privacy protection device of claim 2, wherein the front vent is in communication with an acoustic outlet end of the sound generating unit, and the reverse vent is in communication with a rear end of the sound generating unit; and the front vent and the reverse vent are located in the mount structure and sealed from each other.

4. The sound privacy protection device of claim 2, wherein the EEP is an origin of a spatial coordinate system, with a direction from the EEP to an outer side of the ear defined as a positive X-axis, a direction from the EEP to a front side of the ear defined as a positive Y-axis, and a direction from the EEP to an upper side of the ear defined as a positive Z-axis; coordinates of the acoustic outlet end of the front vent are between (0 mm, −12.2 mm, −5.2 mm) and (15.3 mm, 3.2 mm, 13.3 mm); and coordinates of an acoustic outlet end of the reverse vent are between (5 mm, −22 mm, −3.2 mm) and (27.3 mm, 15 mm, 18 mm).

5. The sound privacy protection device of claim 2, wherein the ERP is an origin of a spatial coordinate system, with a direction from the ERP to an outer side of the ear defined as a positive X-axis, a direction from the ERP to a front side of the ear defined as a positive Y-axis, and a direction from the ERP to an upper side of the ear defined as a positive Z-axis; coordinates of the acoustic outlet end of the front vent are between (0 mm, −9.2 mm, −18.2 mm) and (7.3 mm, 10.4 mm, 8.2 mm); and coordinates of an acoustic outlet end of the reverse vent are between (5 mm, −15.2 mm, −3.2 mm) and (20.3 mm, 12 mm, 13 mm).

6. The sound privacy protection device of claim 2, wherein a cross-sectional area of the front vent is 10% to 35% of an area of a diaphragm of the sound generating unit.

7. The sound privacy protection device of claim 2, wherein a cross-sectional area of the reverse vent is 10% to 30% of an area of a diaphragm of the sound generating unit.

8. The sound privacy protection device of claim 2, wherein the number of the front vent is equal to the number of the reverse vent.

9. The sound privacy protection device of claim 2, wherein the front vent or the reverse vent has a circular shape, a square shape, an elliptical shape or a racetrack shape, or any combination thereof.

10. The sound privacy protection device of claim 2, wherein the front vent is arranged on one side of the mount structure facing toward an ear canal; and the reverse vent is arranged on one side of the mount structure facing away from the ear canal.
